(19) United States
(12) Patent Application Publication
(10) Pub. No.: US 2024/0243594 A1
(43) Pub. Date: Jul. 18, 2024

(54) REMOVABLE AND RECHARGEABLE POWER BANK FOR USE WITH SMALL ELECTRONIC DEVICES AND WORK LIGHTS

(71) Applicant: Saied Hussaini, Miami, FL (US)

(72) Inventor: Saied Hussaini, Miami, FL (US)

(21) Appl. No.: 18/433,452

(22) Filed: Feb. 6, 2024

Related U.S. Application Data
(63) Continuation-in-part of application No. 29/824,194, filed on Jan. 22, 2022, now Pat. No. D013922.
(63) Continuation-in-part of application No. 29/825,705, filed on Feb. 4, 2022, now Pat. No. D012337.

(51) Int. Cl. H02J 7/00; F21L 4/00; H01M 10/0525; H01M 10/46; H01M 50/204

(52) U.S. Cl. CPC H02J 7/0045; H01M 10/0525; H01M 10/46; H01M 50/204; H02J 7/0013; F21L 4/00

(57) ABSTRACT

The present invention is a removable and rechargeable power bank capable of powering small electronic devices as well as a large flashlight, worklight, or spotlight. The power bank includes USB input and output ports to charge mobile phones (e.g. iPhones, iPads Androids, tablets, or other smart device). The power bank is rectangular in shape and provides power to work lights or flashlights configured with a corresponding hollow rectangular battery bay.

### STATEMENT REGARDING FEDERALLY SPONSORED RESEARCH OR DEVELOPMENT

This invention has been created without the sponsorship or funding of any federally sponsored research or development program.

### FIELD OF INVENTION

The present invention relates to removable and rechargeable battery or power bank for use with work lights, spotlights, smart phones, electronic devices that utilize a USB port for charging.

### BACKGROUND OF THE INVENTION

Presently there are many battery packs, portable batteries, removable batteries, rechargeable batteries, or a combination of removable and rechargeable batteries. These variety of batteries are specifically made to power one or very similar types of tools, electronic devices, power tools and other battery power devices. For instance, a computer battery may be removeable and rechargeable, but is only able to power a computer versus a tablet or smart phone or a flashlight. This would also apply to power tools such as drills, saws, cutters, impact devices and some leaf blowers. Another instance includes a computer battery that is not removable but is rechargeable, which instance would apply to a smart watch, a power toothbrush, hair shavers, or a meat carving knife.

Although there exists battery packs or power banks that charge multiple devices utilizing multiple plug options including USA A, USB B, and USB C all in Micro, Mini, 2.0, or 3.0 versions. Despite the variety of USB plugs with corresponding ports, the associated power source charges small electronic devices and not larger devices or power tools such as drills, impact devices, flashlights, or heavy-duty work lights. In the event of an emergency such as the loss of power, these small devices are not able to power a flashlight for a significant period of time, if at all. Vice versa, the rechargeable battery from a power tool will also become obsolete in the event of a power outage, as it cannot charge or provide power to any other device. Thus, there is a void in the field of battery packs for a removable and rechargeable long lasting power bank capable of powering small electronics with USB ports as well as a large flashlight, worklight, or spotlight.

### SUMMARY OF INVENTION

The present invention fills the void in the field of battery packs or power banks for a removable and rechargeable long lasting power bank capable of powering small electronics with USB ports as well as a large flashlight, worklight, or spotlight. The removeable and rechargeable power bank of this invention is able to charge mobile phones (e.g. iPhones, iPads Androids, tablets, or other smart device) as well as large flashlights and work lights. Additionally, this invention includes TSA approved components to ensure easy passes through security checkpoints, making it easy for travel to and access at your desired destination.

This invention is also designed to work with the Spotlight (Des 29/825,705) and Worklight (Des 29/824,194). Depending on the desired power level and runtime, the invention may come in single pack or multiple packs in order to charger or power the Spotlight, Worklight, or other electronic devices. Another advantage of the power bank of this invention is that it can be removed and replaced after end of life (EOL) of the battery or after 800 cycles usage of lithium-ion cells, thus consumers do not have to dispose of the whole product (including the battery), only the power bank portion. As is known in the industry, a lithium-ion or Li-ion battery is a type of rechargeable battery that uses the reversible intercalation of Li⁺ ions into electronically conducting solids to store energy. Currently, there is no known manufacturer or inventor who has designed, developed, or marketed a similar concept for a removable and rechargeable power bank and/or one that may be utilized with their products. Undoubtably, there are tool manufacturers with battery packs that are removable and rechargeable for drills, saws, cutters and impact devices, however, none can be used as the power bank to charge other or external devices.

The present invention is a power bank comprising lithium-ion cells housed in a durable rectangular casing with USB ports embedded on one side, and the USB ports are covered by hinged compartment doors. The compartment doors open to expose the USB ports and when closed give the power bank a seamless finish. The rectangular power bank fits into a battery bay designed to accept its dimension and configuration, such as the Spotlight and Worklight, while the USB ports provide charging options for small electronic devices.

### BRIEF DESCRIPTION OF THE DRAWINGS

FIG. 1 is a exploded perspective view of the present invention and the open charging port thereof;

FIG. 2 is an exploded side view of the present invention in use with the Spotlight;

FIG. 3 is an exploded rear view of the present invention and the battery bay portion of the Spotlight;

FIG. 4 is an exploded view of the present invention and the battery bay portion of the Worklight;

FIG. 5 is an exploded view of the battery bay portion of the Worklight;

### DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

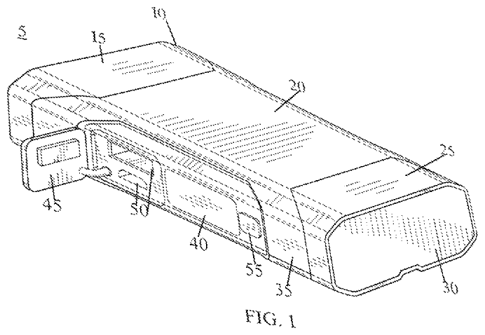

As shown in FIG. 1, the present invention is a removeable and rechargeable power bank 5 containing lithium-ion cells housed in a durable rectangular casing 10 that comprises three segments: a first segment 15 located at the front (not depicted) of the power bank 5; a second or middle segment 20; and a third segment 25 located at the back or rear 30 of the power bank 5. The power bank 5 has a right side (not depicted) and a left side 35. On the left side 35 of the power bank 5 and in the middle segment 20 there are USB port doors shown in the closed position 40 and the opened position 45. The opened USB port door 45 exposes USB ports 50 utilized to charge small electronic devices such as smart phones, smart watches, and tablets. The middle segment of the left side 35 of the power bank 5 also includes a power button 55 to activate the charging ports 50. The removeable and rechargeable power bank 5 is able to charge mobile phones (e.g. iPhones, iPads, Androids, tablets, and other smart devices) as well as large flashlights and work lights.

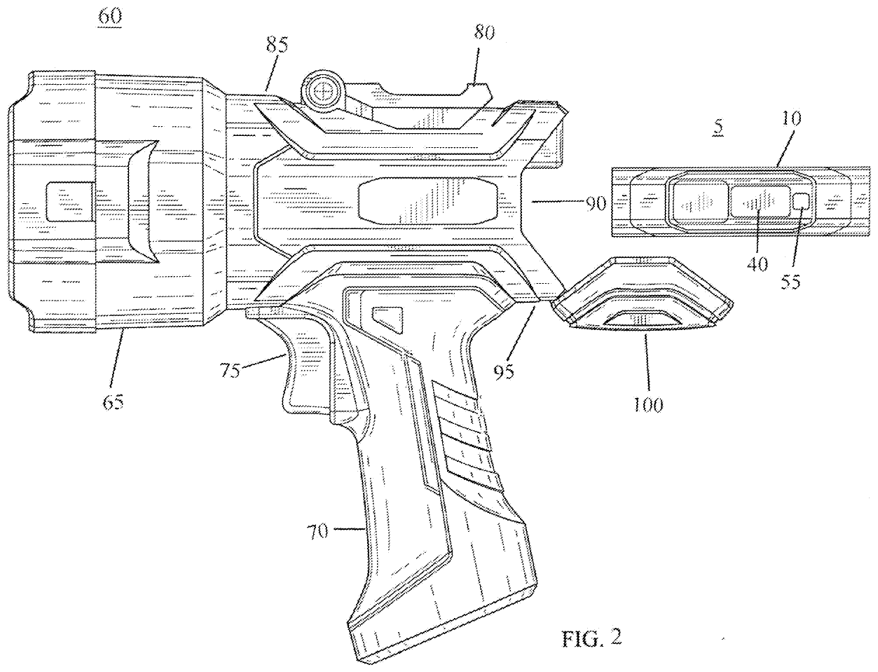

As shown in FIG. 2, the power bank 5 as used with the Spotlight 60 (Des 29/825,705) which comprises among other components (as depicted): a flashlight portion 65 with focused beam housed (not depicted) in a contiguous shaft, a hand-held portion 70 in a gun configuration, a trigger portion 75 for turning on and off the spotlight 60; with a foldable carrying handle 80 on the top portion 85 of the flashlight portion 65; and a battery bay 90 located at the back 95 of the flashlight portion 65 of the Spotlight 60 and which has a door 100 shown in the open position. Inside of the battery bay 90 is hollow having a rectangular shape that corresponds to the shape and configuration of the power bank 5. To power the Spotlight 60, the removable and rechargeable power bank 5 is inserted inside of the battery bay 90, the door 100 is closed to secure the power bank 5, and the trigger portion 75 is activated to turn on the flashlight portion 65.

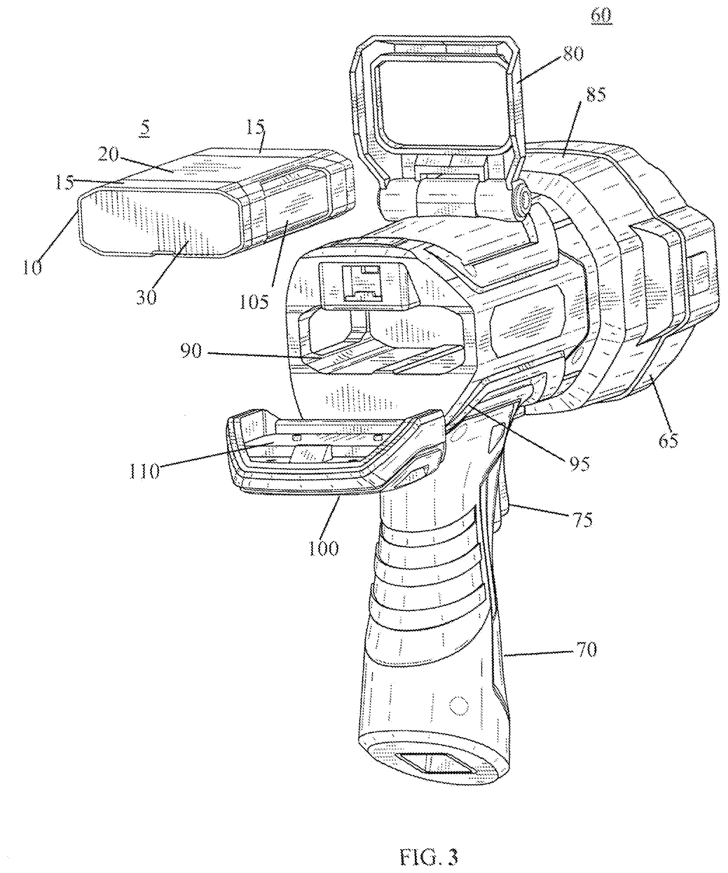

FIG. 3 is an exploded rear view of the power bank 5 and the Spotlight 60. As shown, the foldable carrying handle 80 on the top portion 85 of the flashlight portion 65 is in the upright position illustrating the mode for carry the Spotlight 60 under normal use or emergency conditions. Also shown in FIG. 3 is the right side 105 of the power bank 5 and the anterior 110 of the door 100 of the battery bay 90.

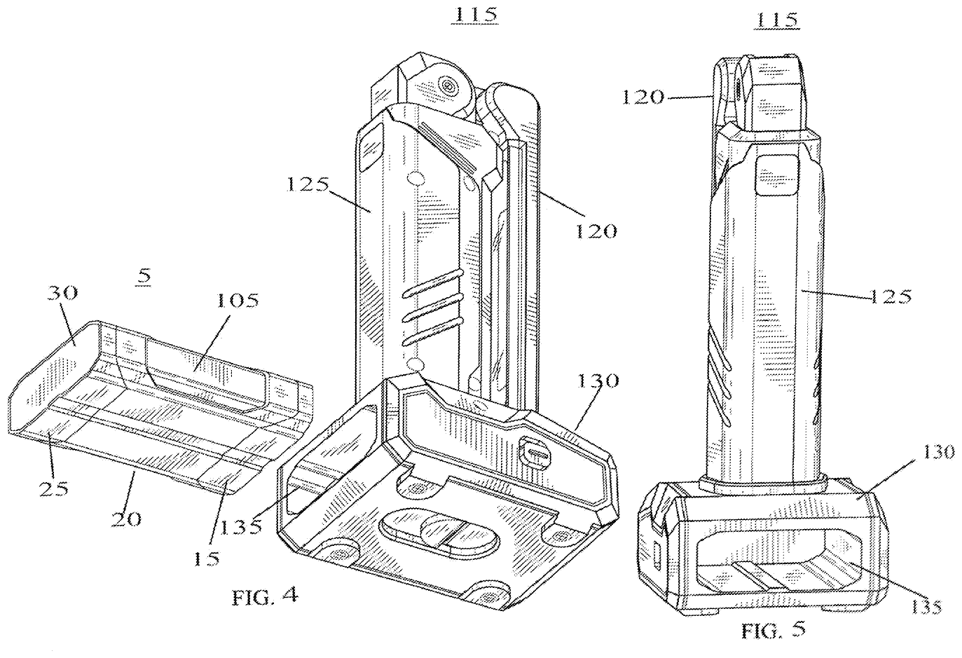

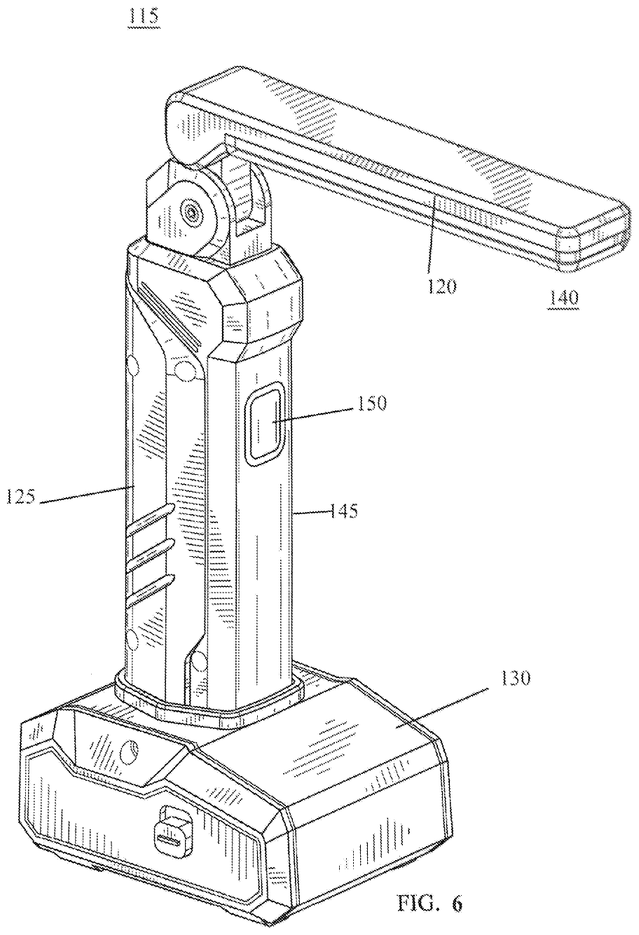

FIGS. 4 and 5 illustrate the power bank 5 as used with the Worklight 115 (Des 29/824,194) which comprises among other components (as depicted): a hinged foldable worklight 120 fastened to a vertical shaft 125, which shaft 125 is further connected to a rectangular shaped base 130 that contains a battery bay 135 for housing the removable and rechargeable power bank 5 of the present invention. As shown, the battery bay 135 is hollow having a rectangular shape that corresponds to the Worklight 115 and does not have a door.

As shown in FIG. 6, the hinged foldable worklight 120 is in the unfolded position 140 exposing a front portion 145 of the shaft 125 and a power button 150 located on the upper portion of the shaft 125. As shown in FIG. 5, to power the Worklight 115, the removable and rechargeable power bank 5 is inserted inside of the battery bay 135 and for secure fit during use or transport, and as shown in FIG. 6, the power button 140 is activated to turn on the worklight 120.

The life expectancy of the power bank 5 is in the range of 500-700 cycles (depletion and recharge). In particular for the Worklight and Spotlight, it depends on the device's output Lumens (LMS). For example, a 4000 LMS Worklight 115 would provide 3-4 hours of light, whereas a 2000 LMS Spotlight would provide 4-5 hours of light. Additionally, the power bank 5 is able to charge multiple small electronic devices. Overall, the life expectancy of the power bank 5 is in the range of 500-700 cycles for regular and/or emergency use.

In a preferred embodiment, the power bank 5 is uniquely designed to fit into and power the Worklight 115 and Spotlight 60 and includes USB Type A and Type C to power and charge other devices such as smart phones, smart watches, and tablets. However, this not meant to be limiting, as in other embodiments may include other USB ports or other power input ports known to one of ordinary skill in the art to which power ports belong.

### EQUIVALENTS

Those skilled in the art will recognize or be able to ascertain using no more than routine experimentation, many equivalents to the specific embodiments of the invention described herein. Such equivalents are intended to be encompassed by the claims.

What is claimed is:

1. A removeable and rechargeable power bank containing lithium-ion cells housed in a durable casing comprising:
a rectangular housing having a front, left side, right side, and a back of the power bank;
a first segment located at the front of the power bank; a second or middle segment; and a third segment located at the back of the power bank;
USB ports located in the middle segment and on the left side of the power bank; and
said USB ports are covered by a closed door and are exposed by the opened door; and
the opened door facilitates the charging of small electronic devices via the USB ports; and
the power bank is used to power corresponding work lights having a hollow rectangular battery bay.
